(19) United States
(12) Patent Application Publication
(10) Pub. No.: US 2001/0048364 A1
(43) Pub. Date: Dec. 6, 2001

(54) Remote-to-remote position locating system

(76) Inventors: Robert Michael Kalthoff, Cincinnati, OH (US); Rudy Siegel, Cincinnati, OH (US)

Correspondence Address: David H. Brinkman, Wood, Herron & Evans, L.L.P., 2700 Carew Tower, 441 Vine Street, Cincinnati, OH, 45202-2917, US

(21) Appl. No.: 09/791,132

(22) Filed: Feb. 22, 2001

Related U.S. Application Data
(60) Provisional application No. 60/184,248, filed on Feb. 23, 2000.

(51) Int. Cl. G08B 23/00

(52) U.S. Cl. 340/573.1; 340/989; 340/825.49

(57) ABSTRACT

A position locating system includes one or more target monitoring devices that are configured to monitor and display the position of one or more selected target devices, which may include one or more selected target monitoring devices. The target monitoring devices and target devices communicate through a wireless communication network with a data processing system, such as a data center, that receives and stores geographic position data and other data transmitted from the target devices, and also preferably from the target monitoring devices. The position of a selected target device is preferably displayed on a display of the target monitoring device as at least one of a distance between the target monitoring device and the selected target device, a compass direction from the target monitoring device to the selected target device in degrees from magnetic North, a relative compass heading from the target monitoring device to the selected target device, and/or the nearest geographical address of the selected target device which is derived from a GEO-Coded Address (GCA) database preferably maintained at the data processing system.

The present application claims the filing benefit of U.S. Provisional Application No. 60/184,248, filed Feb. 23, 2000, the disclosure of which is hereby incorporated herein by reference in its entirety.

### FIELD OF THE INVENTION

The present invention relates generally to tracking and monitoring systems and, more particularly, to a position locating system for enabling the location of a person or object to be monitored and displayed.

### BACKGROUND OF THE INVENTION

Many different systems and approaches have been developed in the past to enable the location of a person or object to be monitored and displayed. Generally, these systems and approaches can be classified as either requiring direct data communication between a device being monitored and a monitoring device or, alternatively, direct data communication between the device being monitored and a central monitoring station.

For example, several position location or monitoring systems are known that include monitored devices and monitoring devices that communicate directly with each other through a wireless media, such as through radio (RF) signals. By way of example, the monitored device, such as carried by a child, may transmit a radio signal that is monitored by the monitoring device, such as carried by a parent. In the event the signal received by the parent's monitoring device falls below a predetermined signal strength, the monitoring device transmits a signal to the child's monitored device to activate an alarm and/or an alarm is activated on the parent's monitoring device. The monitoring device may include an antenna array that is capable of determining the angle of propagation of the radio signal from the child's monitored device so that the relative direction of the child can be determined and displayed.

Other monitoring and locating systems have been developed in the past wherein each of the monitored and monitoring devices includes a position determination circuit, such as a GPS receiver and GPS processor, so that the latitude and longitude coordinates of the monitored and monitoring devices can be determined. The monitored and monitoring devices have wireless communication capability so that the monitored device transmits its geographic coordinates to the monitoring device. The monitoring device uses its own derived geographic position data, and the geographic position data transmitted by the monitored device, to derive the distance and direction between the two devices.

Further, monitoring and locating systems have been developed in the past wherein the monitored device transmits its geographic location to a central monitoring station where that information can be displayed. The monitored device may include a GPS receiver and GPS processor so that the latitude and longitude coordinates of the monitored device can be determined and transmitted to the central monitoring station. The central monitoring station may include a GEO-Coded Address database so that the position of the monitored device can be displayed on a map.

While these various approaches for monitoring the location of persons or objects may be suitable for the particular purpose to which they address, they suffer from several shortcomings and drawbacks. For example, those approaches that require direct communication between the monitored device and the monitoring device are not well suited for tracking or monitoring applications that require a significant distance separation between the monitored and monitored devices so that direct communication between the devices is not possible. Without an established communication link between the two devices, the monitoring device simply cannot monitor the position of the monitored device. Moreover, those approaches that require direct communication between the monitored device and a central monitoring station are not suited for applications that require a portable monitoring device to track and monitor the position of a monitored device.

Accordingly, there is a need for an improved position tracking and monitoring system and approach that does not require direct communication between a monitored device and a monitoring device to permit the monitoring device to monitor and display the location of the monitored device. There is also a need for an improved position tracking and monitoring system and approach that more effectively uses the position data generated by the monitored device for tracking and monitoring purposes.

### SUMMARY OF THE INVENTION

The present invention overcomes the foregoing and other shortcomings and drawbacks of position locating systems and methods of monitoring and displaying the location of a person or object heretofore known. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a position locating system includes one or more target monitoring devices that are configured to monitor and display the position of one or more selected target devices, which may include one or more selected target monitoring devices. The target monitoring devices and target devices communicate through a wireless communication network with a data processing system, such as a data center, that receives and stores geographic position data and other data transmitted from the target devices, and also preferably from the target monitoring devices.

The position of a selected target device is preferably displayed on a display of the target monitoring device as at least one of a distance between the target monitoring device and the selected target device, a compass direction from the target monitoring device to the selected target device in degrees from magnetic North, a relative compass heading from the target monitoring device to the selected target device, and/or the nearest geographical address of the selected target device which is derived from a GEO-Coded Address (GCA) database preferably maintained at the data processing system.

In one embodiment of the present invention, the target devices, and preferably also the target monitoring devices, are configured to receive signals from satellites of the Global Positioning System (GPS). The target devices and target monitoring devices preferably include GPS receivers and GPS processors from which the geographic positions, in latitude and longitude coordinates, of the target devices and target monitoring devices can be derived. Each of the target monitoring devices and the target devices preferably includes a wireless communication circuit that is operable to transmit the derived geographic coordinates of the respective target monitoring device and target device to the data processing system through the wireless communication network. The target monitoring devices preferably include a compass circuit that is operable to derive the present compass heading of the target monitor device in degrees from magnetic North. Preferably, the target monitoring device is further operable to transmit the compass heading of the device to the data processing system.

In operation of the position locating system of the present invention, a user of the target monitoring device is able to select one of several target devices that are listed on a pre-programmed menu displayed on the target monitoring device and request the location of that selected target device. In response to the received request, the data processing system evaluates the last known locations of the target monitoring device and the selected target device to establish data that represents the distance between the target monitoring device and the target device, the compass direction from the target monitoring device to the target device in degrees from magnetic North, and the nearest geographic address of the target device. In the event the target monitoring device includes a compass circuit that has transmitted the compass heading of the target monitoring device in degrees from magnetic North, the data processing system uses the compass heading of the target monitoring device and the derived compass direction from the target monitoring device to the target device in degrees from magnetic North to establish data that represents a relative compass heading from the target monitoring device to the target device. The data processing system is preferably operable to transmit through the wireless communication network at least one, and preferably all of the distance, compass direction, relative compass heading, and nearest geographic address data to the target monitoring device for display.

Alternatively, the wireless communication network may include position location circuits that are operable to determine the locations of the target monitoring devices and the target devices from wireless signals transmitted by the devices. The position location circuits may use various algorithms known to those of ordinary skill in the art, such as time difference or arrival, angle of arrival, enhanced observed time difference or multi-path finger printing, to derive the geographic locations, such as latitude and longitude, of the target monitoring devices and the target devices from the wireless signals transmitted by the devices. The position location circuits are coupled to the data processing system and apply data representing the derived geographic locations of the target monitoring devices and the target devices to the data processing system for processing.

The above features and advantages of the present invention will be better understood with reference to the accompanying figures and detailed description. It will also be understood that the particular drawings illustrating the invention are exemplary only and are not to be regarded as limitations of the invention.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1A is a schematic view of a position locating system in accordance with one embodiment of the present invention;

FIG. 1B is a view similar to FIG. 1A illustrating a position locating system in accordance with an alternative embodiment of the present invention;

FIG. 1C is a block diagram illustrating data transfer in the position locating systems of FIGS. 1A and 1B;

FIG. 2 is a schematic view illustrating data transfer in an exemplary embodiment of the position locating system of FIG. 1A;

FIG. 3 is a front elevational view of a target monitoring device and an exemplary display of the target monitoring device in accordance with one embodiment of the present invention, illustrating the target monitoring device as a wireless phone;

FIGS. 3A-3F are additional exemplary displays of the target monitoring device of FIG. 3;

FIG. 4 is a front elevational view of a target device in accordance with one embodiment of the present invention;

FIG. 5 is a rear elevational view of the target device of FIG. 4;

FIG. 6 is a block diagram of the target monitoring device of FIG. 3 in accordance with one embodiment of the present invention;

FIG. 7 is a block diagram of the target device of FIGS. 4-5 in accordance with one embodiment of the present invention;

FIG. 8 is a perspective view of a target monitoring device or a target device in accordance with an alternative embodiment of the present invention, illustrating the target monitoring device or the target device as a wrist-worn watch;

FIG. 9 is a top elevational view of a target monitoring device or a target device in accordance with another alternative embodiment of the present invention, illustrating the target monitoring device or the target device as a wrist-worn watch;

FIG. 10 is a side elevational view of the target monitoring device or the target device of FIG. 9;

FIG. 11 is a side elevational view of a target monitoring device or a target device in accordance with an yet another alternative embodiment of the present invention, illustrating the target monitoring device or the target device as a wrist-worn watch;

FIG. 12 is a front elevational view of a computer display in accordance with the principles of the present invention;

FIG. 13 is view similar to FIG. 1A illustrating a position locating system in accordance with yet another alternative embodiment of the present invention;

FIG. 14A is a diagrammatic view illustrating an exemplary compass heading of a target monitoring device in degrees from magnetic North and an exemplary compass direction from the target monitoring device to a target device in degrees from magnetic North;

FIG. 14B is a diagrammatic view illustrating an exemplary relative compass heading from the target monitoring device to the target device, illustrated as a graphical vector;

FIG. 15A is a view similar to FIG. 14A illustrating a further exemplary compass heading of a target monitoring device in degrees from magnetic North and a further exemplary compass direction from the target monitoring device to a target device in degrees from magnetic North;

FIG. 15B is a view similar to FIG. 14B illustrating a further exemplary relative compass heading from the target monitoring device to the target device, illustrated as a graphical vector;

FIG. 16A is a view similar to FIG. 3 illustrating yet another exemplary display of the target monitoring device of FIG. 3; and

FIG. 16B is a view similar to FIGS. 3A-3F illustrating still yet another exemplary display of the target monitoring device of FIG. 3.

### DETAILED DESCRIPTION OF THE PREFERRED EMBODIMENT

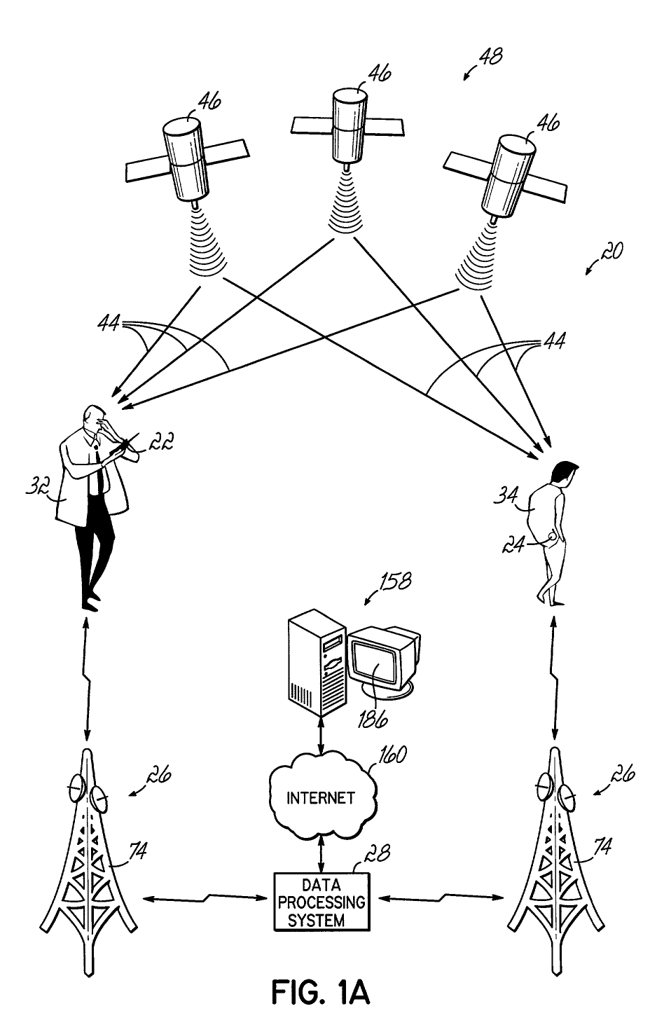

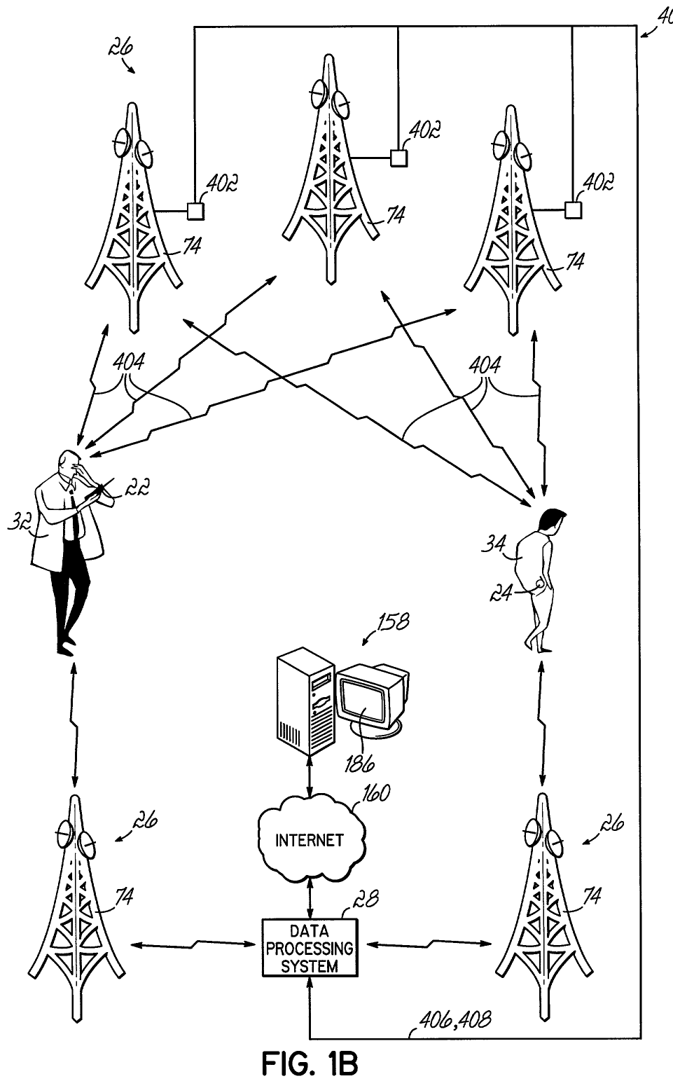

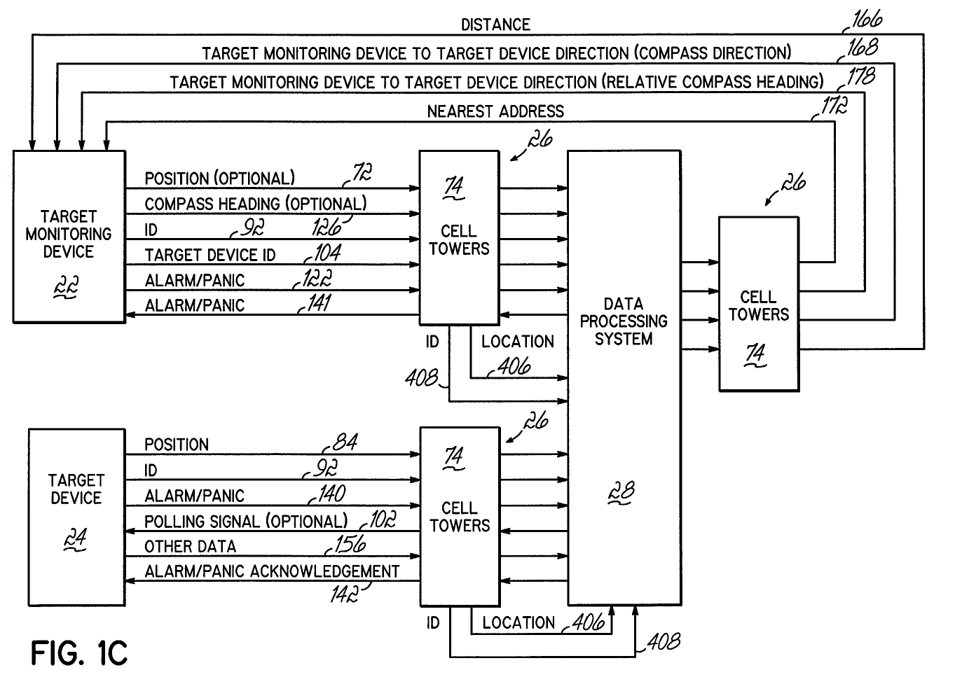

With reference to the Figures, and to FIG. 1A in particular, a position locating system 20 in accordance with one embodiment of the present invention is shown. As will be described in greater detail below, position locating system 20 includes one or more target monitoring devices 22 that are configured to monitor and display the position of one or more selected target devices 24, which may include other selected target monitoring devices 22. As used herein, it will be understood that a target monitoring device 22 is considered to be a “target” device when the position of that target monitoring device 22 is requested by another target monitoring device 22 as described in detail below. The target monitoring devices 22 and target devices 24 communicate through a wireless communication network 26 with a data processing system 28, such as a data center, that receives and stores geographic position data and other data transmitted from the target devices 24 and preferably also from the target monitoring devices 22 as will be described in greater detail below.

The position of a selected target device 24 is preferably displayed on a display 30 of the target monitoring device 22 as at least one of a distance between the target monitoring device 22 and the selected target device 24, a compass direction from the target monitoring device 22 to the selected target device 24 in degrees from magnetic North, a relative compass heading from the target monitoring device 22 to the selected target device 24, and/or the nearest geographical address of the selected target device 24 which is derived from a GEO-Coded Address (GCA) database preferably maintained at the data processing system 28.

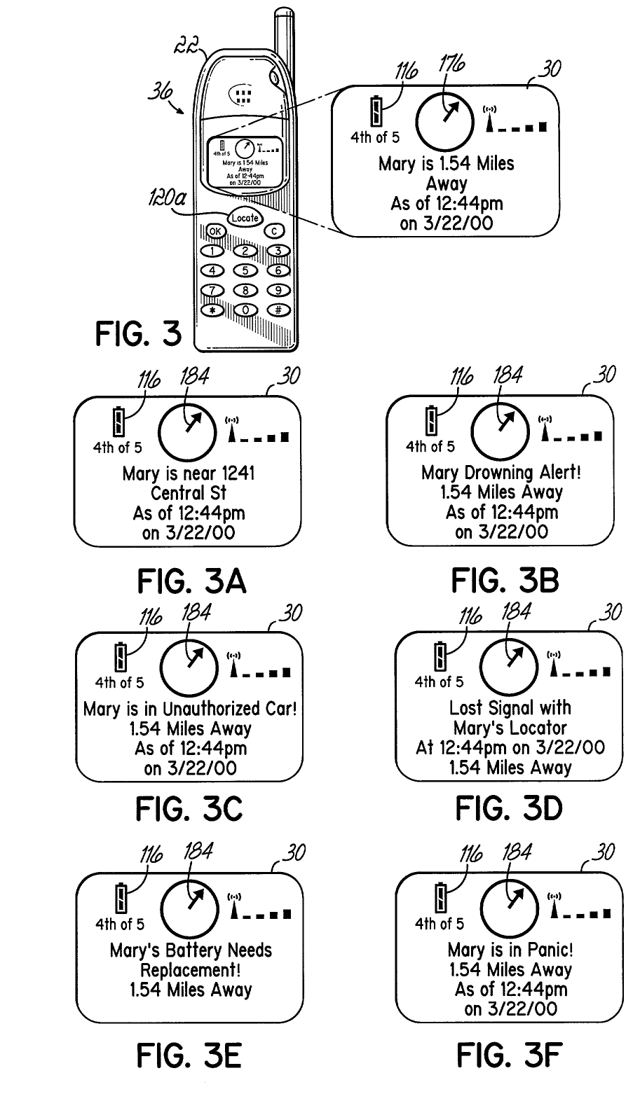

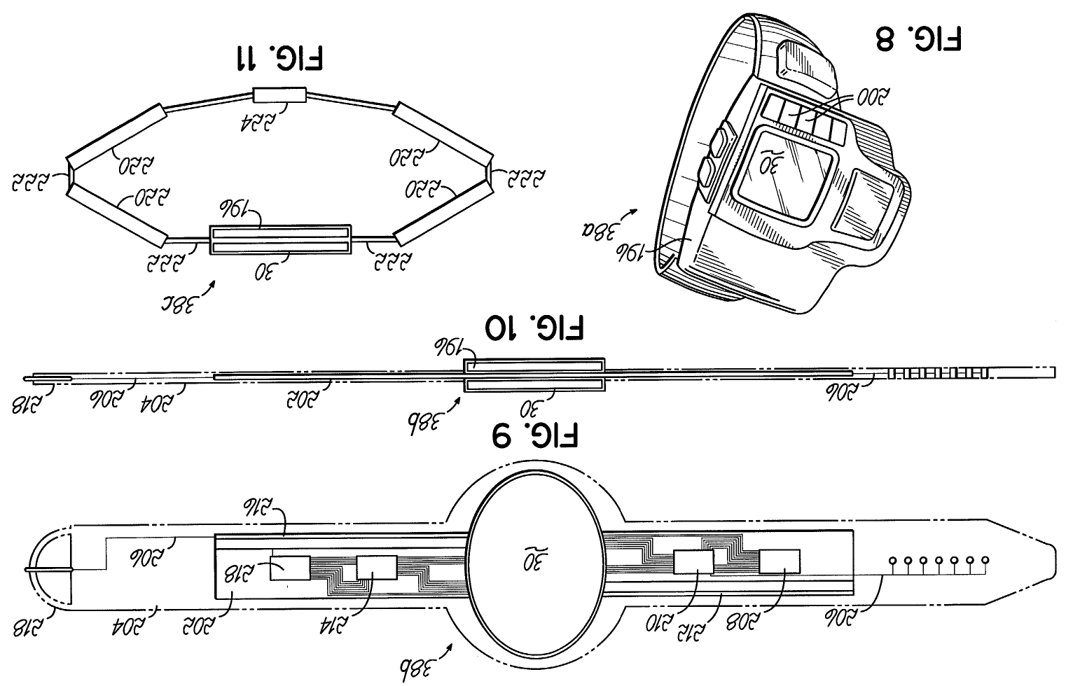

When used in person-to-person position locating applications as shown in FIG. 1A, the target monitoring devices 22 and the target devices 24 are preferably sized and configured to be easily carried or worn by individuals 32 and 34, such as by a parent and a child, respectively. Additionally, the target devices 24 may be placed on pets (not shown) or in objects such as vehicles (not shown) or luggage (not shown) so that the location of the pet or object can me monitored and displayed in accordance with the principles of the present invention. As will be described in greater detail below, the target monitoring devices 22 may be implemented within a wireless telephone 36, as shown in FIG. 3 for example, or alternatively, within a wrist-worn watch device 38a, 38b and 38c, as shown in FIGS. 8-11 for example. In alternative embodiments of the present invention, the target monitoring devices 22 may be implemented in pagers, personal data assistants (PDA's), Internet access devices or similar wireless data processing devices having a display (not shown).

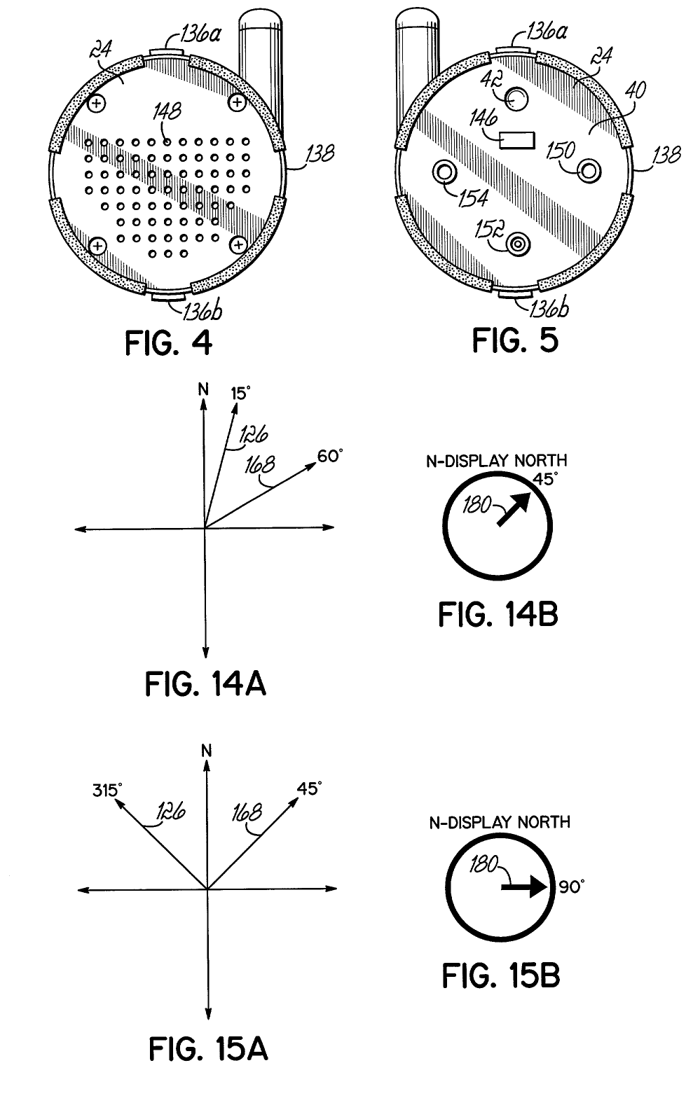

The target devices 24 may be implemented as a relatively small clip-on device that can be worn on a belt or as a device that can be easily placed within a pocket of the individual 34 (FIG. 1A), as shown in FIGS. 4-5 for example. As shown in FIG. 5, a rear face 40 of the target device 24 preferably includes an aperture 42 for releasably retaining a post (not shown) associated with a belt or hip worn clip device (not shown). Alternatively, the target devices 24 may be implemented within wrist-worn device 38a, 38b and 38c as shown in FIGS. 8-11, a pager, a personal data assistant (PDA), an Internet access device or a similar wireless data processing device having a display (not shown) for example. Of course, it will be appreciated that the target monitoring devices 22 and the target devices 24 may be configured in many other shapes and sizes, or be implemented in other types of devices (not shown), without departing from the spirit and scope of the present invention.

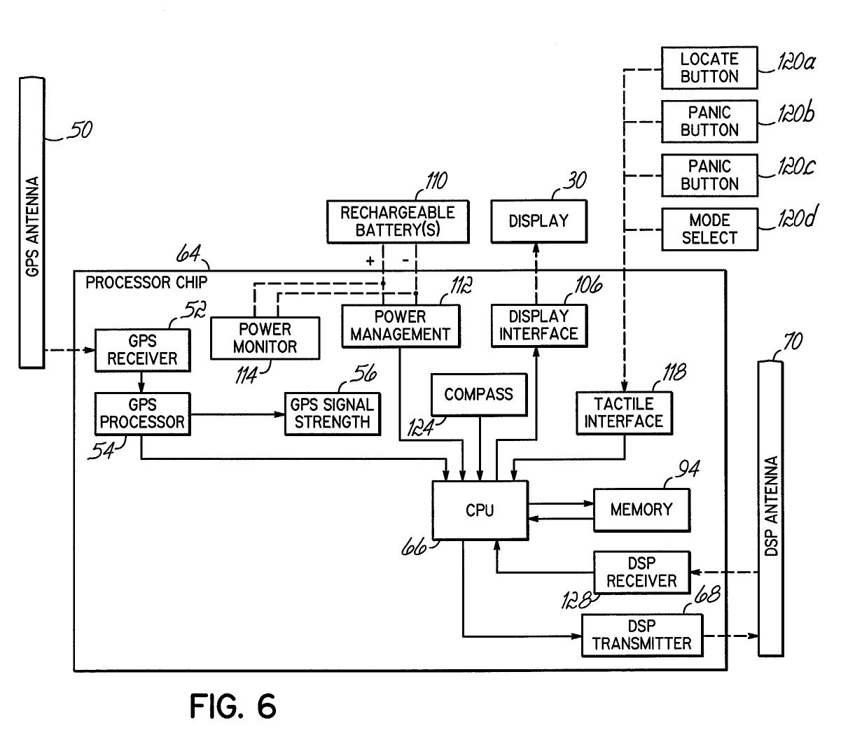

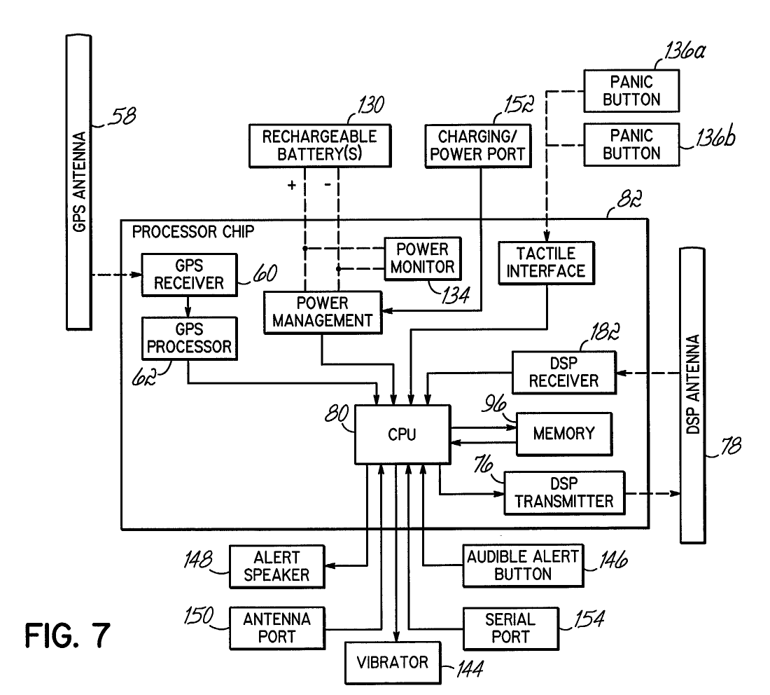

Further referring to FIG. 1A, the target monitoring devices 22 and the target devices 24 are preferably configured to receive signals 44 from satellites 46 of the Global Positioning System (GPS) 48 which comprises multiple satellites broadcasting precise timing signals 44 from atomic clocks. The target monitoring device 22 preferably includes, although not required in certain embodiments, a GPS antenna 50, GPS receiver 52 and a GPS processor 54 (FIG. 6) that use precise and well-developed triangulation formulas to determine the geographic position of the target monitoring device 22 in geographic coordinates, namely latitude and longitude, from the timing signals 44 transmitted by the GPS satellites 46. A GPS signal strength circuit 56 (FIG. 6) is preferably coupled to the GPS processor 54 for providing a visual indication (not shown) of the received GPS signal strength. Similarly, the target device 24 preferably includes a GPS antenna 58, GPS receiver 60 and a GPS processor 62 (FIG. 7) from which the geographic position of the target device 24 in latitude and longitude coordinates can be derived. It will be appreciated that while GPS information may be preferred for deriving the geographic positions of the target monitoring devices 22 and the target devices 24, many other position information systems known to those of ordinary skill in the art are possible as well for deriving latitude and longitude coordinates of the target monitoring devices 22 and target devices 24 without departing from the spirit and scope of the present invention.

As shown in FIGS. 1A and 6 , the target monitoring device 22 preferably includes a processor chip 64 having a central processing unit (CPU) 66 that is operable to receive the geographic position information derived by the GPS receiver 52 and the GPS processor 54. The target monitoring device 22 further includes a wireless communication circuit, preferably comprising a DSP transmitter 68 and a DSP antenna 70 coupled to the CPU 66, that is operable to transmit the derived geographic coordinates of the target monitoring device 22 in an encrypted format, represented by position data 72 in FIG. 1C, to the data processing system 28 through cell towers 74 of the wireless communication network 26. The wireless communication circuit of the target monitoring device 22 may be a TDMA, CDMA, GSM or IDEN-pager device preferably having 2-way Short Messaging Service (SMS) capability or other data transmission capability. Similarly, as shown in FIG. 7, the target device 24 includes a wireless communication circuit, preferably also comprising a DSP transmitter 76 and a DSP antenna 78 coupled to CPU 80 of processor chip 82, that is operable to transmit the derived geographic coordinates of the target device 24 in an encrypted format, represented by position data 84 in FIG. 1C, to the data processing system 28 through cell towers 74 of the wireless communication network 26. The DSP transmitter 76 may also be a TDMA, CDMA, GSM or IDEN-pager device preferably having 2-way Short Messaging Service (SMS) capability or other data transmission capability. As shown in FIG. 1A, the data processing system 28 is operatively coupled to the wireless communication network 26 and includes memory or other storage media for storing the geographic coordinates transmitted from the target monitoring device 22 and the target device 24 and the time and date those coordinates are received.

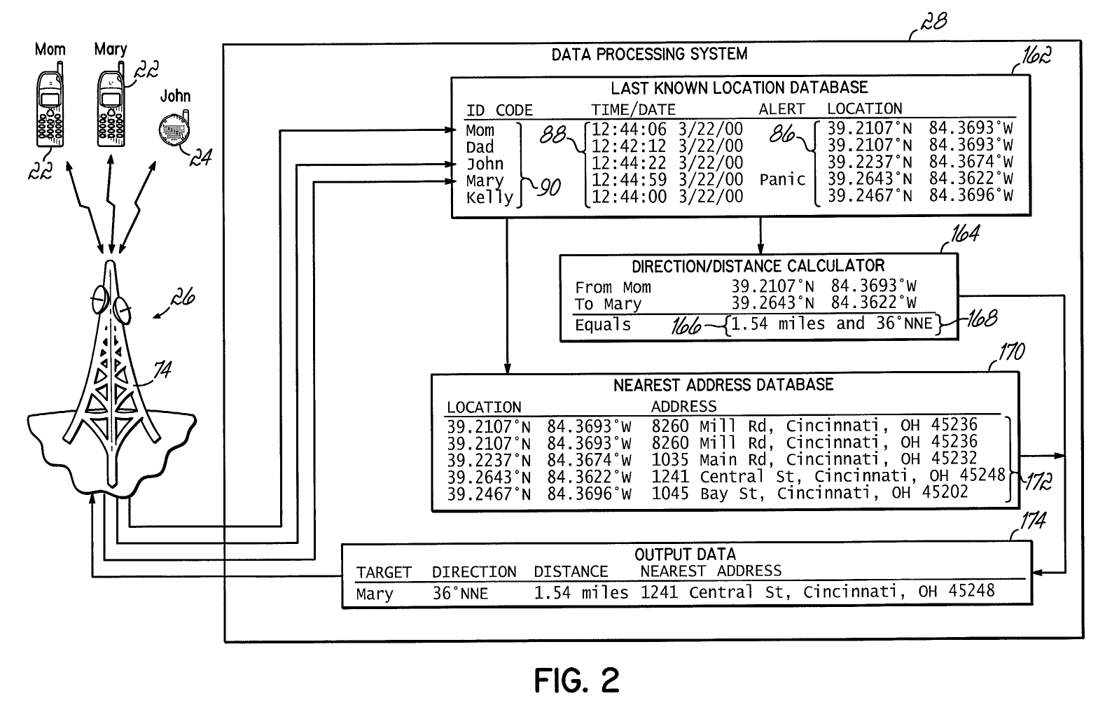

At the data processing system 28, geographic coordinate information transmitted by each of the target monitoring devices 22 and the target devices 24 is preferably stored as last known locations, in latitude and longitude coordinates 86, of the devices 22, 24 (FIG. 2). A date and time stamp 88 (FIG. 2) identifying the date and time at which the geographic position information was either transmitted by the target monitoring device 22 and target device 24, or received at the data processing system 28, is preferably stored with each last known location of the target monitoring devices 22 and the target devices 24 to be stored. Preferably, each target monitoring device 22 and target device 24 has a unique device identifier 90 (FIG. 2), such as the ESN number or telephone number of the devices 22, 24, or other unique device identifier, as represented by ID data 92 in FIG. 1C, that is transmitted to the data processing system 28 with the geographic coordinate information transmitted by the devices 22 and 24. The unique device identifier is stored in memory 94 (FIG. 6) of the target monitoring device 22 and in memory 96 (FIG. 7) of the target device 24. The data processing system 28 is preferably operable to store the geographic coordinates 86 and the date and time stamp information 88 as a record associated with the unique device identifier 90 for each target monitoring device 22 and target device 24, as shown in FIG. 2. The data processing system 28 may store multiple records for each target monitoring device 22 and target device 24 so that the last several known locations of each device 22 and 24 are stored. Alternatively, the data processing system 28 may store only the last known location of each target monitoring device 22 and target device 24 as transmitted by those devices 22, 24.

In one embodiment of the present invention, the target monitoring devices 22 and target devices 24 are configured to transmit their geographic positions to the data processing system 28 on a predetermined interval. The transmission intervals are preferably user selectable, and may vary from between a transmission every one minute to a transmission every five days, for example. Of course, other transmission intervals are possible as well. As shown in FIGS. 6 and 7, the target monitoring device 22 and target device 24 each include memory, such as the memory 94, 96, respectively, which may be used to store the derived geographic positions of the devices 22, 24 between transmission cycles. According to this aspect of the present invention, the stored geographic position data of each device 22, 24 may be transmitted as a block of several geographic positions, rather than as a single geographic position, either on a periodic basis or, alternatively, only upon receipt of a polling signal 102 (FIG. 1C) transmitted by the data processing system 28 as will be described in greater detail below.

Preferably, the position data records maintained at the data processing system 28 are assigned to “accounts” established at the data processing system 28. Each “account” comprises one or more target monitoring devices 22 and one or more target devices 24. For example, an “account” may comprise a family wherein the parents each have a target monitoring device 22 assigned a unique device identifier associated with his or her name, and their children each have a target device 24 assigned a unique device identifier associated with his or her name. In this way, an easily recognizable name or other user-friendly nomenclature can be used to represent an ESN number, telephone number or other unique device identifier for each assigned target monitoring device 22 and target device 24.

Each parent's target monitoring device 22 is programmed with a displayable menu (not shown) that identifies the name or other unique device identifier of his or her spouse and the name or other unique device identifier of each child that is established in the “account”. For example, an established “account” is shown by way of example in FIG. 2 including members “Mom”, “Dad”, “John”, “Mary” and “Kelly”, wherein each name is associated with a unique device identifier of either a target monitoring device 22 or a target device 24. Preferably, the ESN number, telephone number or other unique device identifier associated with each name listed in the menu of the “account” is stored in memory 94 in each target monitoring device 22. As will be described in greater detail below, the user of the target monitoring device 22 is able to select the name or other unique device identifier of each person assigned to the “account” from the displayed menu, to request position information relating to that selected person, as represented by the target device data 104 in FIG. 1C, and to receive position information relating to that selected person from the data processing system 28. The requested position data for the selected person is received from the data processing system 28 over the wireless communication network 26 and displayed on the display 30 of the target monitoring device 22. The display 30 is preferably a high quality liquid crystal display (LCD) or thin film transistor (TFT) display coupled to the CPU 66 through a display interface 106 (FIG. 6).

For security reasons, a user of a target monitoring device 22 preferably cannot obtain position data relating to any person that is not assigned to the “account” of that user. However, it is contemplated that safety personnel, such as members of the fire and police departments, may have access to the position data of an “account” when permitted by members of the “account” or as arranged with a local public service access point. In this way, safety personnel carrying a target monitoring device 22 are able to request and obtain position data of any member assigned to a particular “account” so that individual members of that “account” can be located in the case of an emergency. In accordance with this aspect of the present invention, the unique device identifier for each member of the “account” is transmitted or otherwise made available to safety personnel or the local public service access point so that position data relating to any person in the “account” can be requested by the safety personnel and made available by the data processing system 28.

Further, as shown in FIGS. 16A and 16B, position data of persons outside of a defined “account” may be accessed by a user of a target monitoring device 22 when permission to that data is granted by those persons outside of the “account”. For example, a user of a target monitoring device 22 may create a menu of friends, indicated by numeral 108 in FIG. 16A, so that the user of the target monitoring device 22 is automatically alerted when any one of those friends is within a predetermined distance, such as 500 feet for example. The data processing system 28 is configured to monitor the last known location of the user of the target monitoring device 22, as well as the last known locations of the friends identified in the menu 108, and to provide an alert to the user of the target monitoring device 22 when any one of the friends is within the predetermined area, as illustrated by the display 30 of FIG. 16B.

Referring now to FIG. 6, each target monitoring device 22 includes one or more rechargeable or replaceable batteries 110 that energize the processor chip 64 and other components of the target monitoring device 22. A power management circuit 112 is preferably coupled to the battery 110 to conserve battery power when the target monitoring device 22 is not in use. For example, the power management circuit 112 may comprise a motion sensor or other type of sensor, such as an accelerometer, that is operable to determine that the target monitoring device 22 is idle and therefore not in use. In the event the target monitoring device 22 is determined to be idle, the power management circuit 112 is operable to disconnect the battery 110 from the processor chip 64 and other components of the target monitoring device 22. Of course, other power management schemes well known to those of ordinary skill in the art are possible as well without departing from the spirit and scope of the present invention.

A power monitor circuit 114 is preferably coupled to the battery 110 to provide a visible indication 116 (FIG. 3) or other indication of the battery charge status. Additionally, the power monitor circuit 114 may be configured to apply a “low battery power” signal to the CPU 66 when the voltage of the battery 110 has dropped below a predetermined voltage level. The CPU 66, in turn, may be configured to transmit a “low battery power” signal to the data processing system 28 upon receipt of the “low battery power” signal from the power monitor circuit 114. The data processing system 28 is preferably configured to transmit a “low battery power” signal to other target monitoring devices 22 assigned to the “account” so that a warning of the low battery level in any target monitoring device 22 is provided to other target monitoring devices 22 in the “account”.

The target monitoring device 22 further includes a tactile interface 118 that is coupled between buttons 120a-120d and the CPU 66. Button 120a comprises a “LOCATE” button that may be used to select a particular member of an “account” from a menu (not shown) displayed on the display 30, and to request position information relating to that selected member from the data processing system 28. A single, and preferably a pair of “PANIC” buttons 120b, 120c are provided so that a user of the target monitoring device 22 can transmit an “alarm/panic” signal 122 (FIG. 1C) to the data processing system 28 when one, or preferably both “PANIC” buttons 120b, 120c are activated simultaneously for a predetermined period of time. Upon receipt of the “alarm/panic” signal 122, the data processing system 28 is preferably configured to transmit an “alarm/panic” signal to other target monitoring devices 22 assigned to the “account”, and possibly to security personnel as well, so that selected individuals are immediately notified of the “alarm/panic” situation. The “MODE SELECT” button 120d is provided so that the user can configure the target monitoring device 22 to operate in a selected mode, such as to operate in the mode of a standard wireless telephone. Alternatively, it is contemplated that specific functions of the target monitoring device 22 can be performed from a programmed “function” menu (not shown) having listed functions that can be selected with standard keys on the target monitoring device 22.

The target monitoring device 22 preferably further includes a compass circuit 124 that is operable to derive the present compass heading of the target monitoring device 22 in degrees from magnetic North. The compass circuit 124 is coupled to the CPU 66 which receives the compass heading data of the target monitoring device 22 derived from the compass circuit 124. Preferably, the target monitoring device 22 is further operable to transmit the compass heading of the device 22, as represented by compass heading data 126 in FIG. 1C, to the data processing system 28 with the geographic position data and the unique device identifier of the target monitoring device 22 as described in detail below.

The wireless communication circuit of the target monitoring device 22 further includes a DSP receiver 128 coupled to the DSP antenna 70 and the CPU 66 that communicates over the wireless communication network 26 with the data processing system 28. The DSP receiver 128 is operable to receive requested position data of selected target devices 24, and other data, from the data processing system 28 and to display the position data and other data on the display 30 of the target monitoring device 22 as described in detail below.

As shown in FIG. 7, each target device 24 includes one or more rechargeable batteries 130 that energize the processor chip 82 and other components of target device 24. A power management circuit 132, similar in function to the power management circuit 112 of the target monitoring device 22, is provided to conserve battery power in the target device 24. A power monitor circuit 134, similar in function to the power monitor circuit 114 of the target monitoring device 22, is provided so that a low battery level condition in a target device 24 is alerted to target monitoring devices 22 assigned to the “account”.

A pair of “PANIC” buttons 136a, 136b are provided opposite each other on a circumference 138 (FIGS. 4 and 5) of the target device 24 so that a user of the target device 24 can transmit an “alarm/panic” signal 140 (FIG. 1C) to the data processing system 28 when both “PANIC” buttons 136a, 136b are activated simultaneously for a predetermined period of time. Upon receipt of the “alarm/panic” signal 140, the data processing system 28 is preferably configured to transmit an “alarm/panic” signal 141 (FIG. 1C) to target monitoring devices 22 assigned to the “account”, and possibly to security personnel as well, so that selected individuals are immediately notified of the “alarm/panic” situation.

The data processing system 28 is further preferably configured to transmit an “acknowledgment” signal 142 (FIG. 1C) to the target device 24 that initiated the “alarm/panic” signal 140 upon receipt of the “alarm/panic” signal 140 at the data processing system 28. The target device 24 preferably includes a vibrator 144 (FIG. 7) that is activated to vibrate the target device 24 upon receipt of the “acknowledgment” signal 142 from the data processing system 28. In this way, the individual 34 wearing or carrying the target device 24 is provided a silent confirmation that the “alarm/panic” signal 140 has been received by the data processing system 28.

As shown in FIGS. 4, 5 and 7, the target device 24 preferably includes an audible alert button 146 positioned on the rear face 40 of the target device 24. When the audible alert button 146 is activated for a predetermined period of time, a speaker 148 within the target device 24 emits a loud audible alert, and the “alarm/panic” signal 140 described above is transmitted to the data processing system 28 for transmission to the target monitoring devices 22 assigned to the “account”, and possibly to security personnel and local public service access point as well.

The rear face 40 of the target device 24 further preferably includes an antenna port 150 for connecting the target device 24 to an external antenna (not shown). A charging/power port 152 is provided so that the battery 130 within the device 24 can be recharged through a conventional battery charger (not shown). In accordance with a further aspect of the present invention, the target device 24 includes a serial port 154 that is operable to be connected to a sensor (not shown). The sensor (not shown) is configured to sense a predetermined condition and to apply data representative of the sensed condition to the target device 24 through the serial data port 154. For example, the sensor (not shown) may be a liquid sensor that is operable to detect contact of the target device 24 with water, such as when a child carrying or wearing the target device 24 falls into a pool. The target device 24 may be configured to transmit an “alarm/panic” signal 140 as described above to the data processing system 28 when the sensor detects contact of the target device 24 with water. In this way, target monitoring devices 22 assigned to the same “account”, and possibly safety personnel as well, are alerted promptly of the dangerous event upon receipt of the “alarm/panic” signal transmitted by the data processing system 28.

In accordance with another aspect of the present invention, the sensor (not shown) connected to the serial port 154 may comprise a heat sensor operable to detect heat in the vicinity of the target device 24. For example, data from the heat sensor (not shown) may be used to detect if the target device 24 has been removed from a child. In the event the heat sensor (not shown) indicates a drop in temperature below a predetermined temperature value, the target device 24 may be configured to transmit an “alarm/panic” signal 140 to the data processing system 28. In this way, target monitoring devices 22 assigned to the “account”, and possibly safety personnel as well, are alerted promptly of the dangerous event that the child's target device 24 has been removed from the child's person upon receipt of the “alarm/panic” signal transmitted by the data processing system 28. Of course, it will be appreciated that other contact and non-contact proximity devices are possible as well for detecting removal of the target device 24 from a wearer's person.

In business tracking applications, the sensor (not shown) connected to the target device 24 through the serial port 154 may provide signals representative of a predetermined environmental condition, such as detection or levels of humidity, volatile organic compounds, smoke, oxygen, carbon monoxide, carbon dioxide or other environmental conditions. The sensor data, represented by the “other” data signal 156 in FIG. 1C, is transmitted by the target device 24 with the position data 84 (FIG. 1C) and ID data 92 (FIG. 1C) to the data processing system 28. In this way, the environmental condition in the vicinity of the target device 24, as well as the position of the target device 24, can be monitored and displayed at one or more target monitoring devices 22 assigned to the “account” and at one or more computer systems 158 (one shown in FIG. 1A) coupled to the data 10 processing system 28 through a global information network 160 (FIG. 1A).

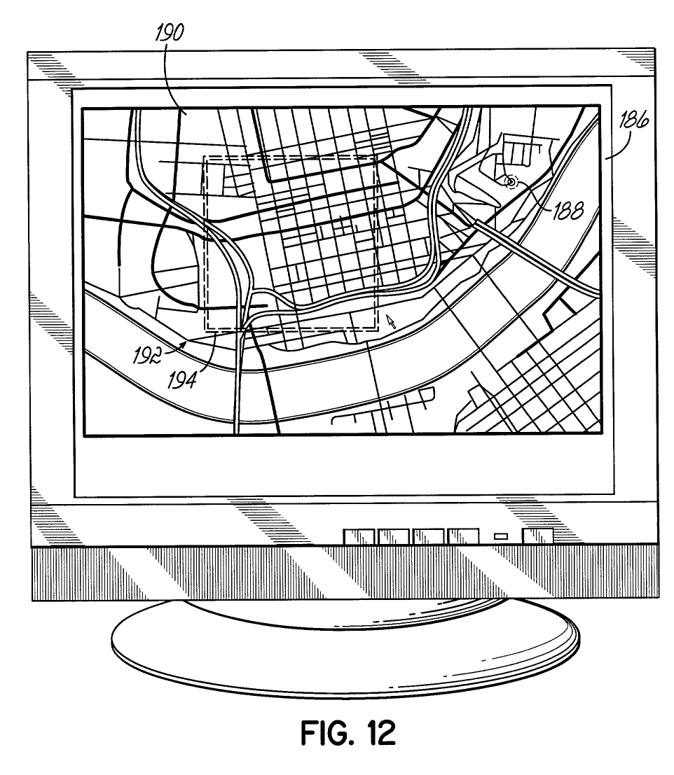

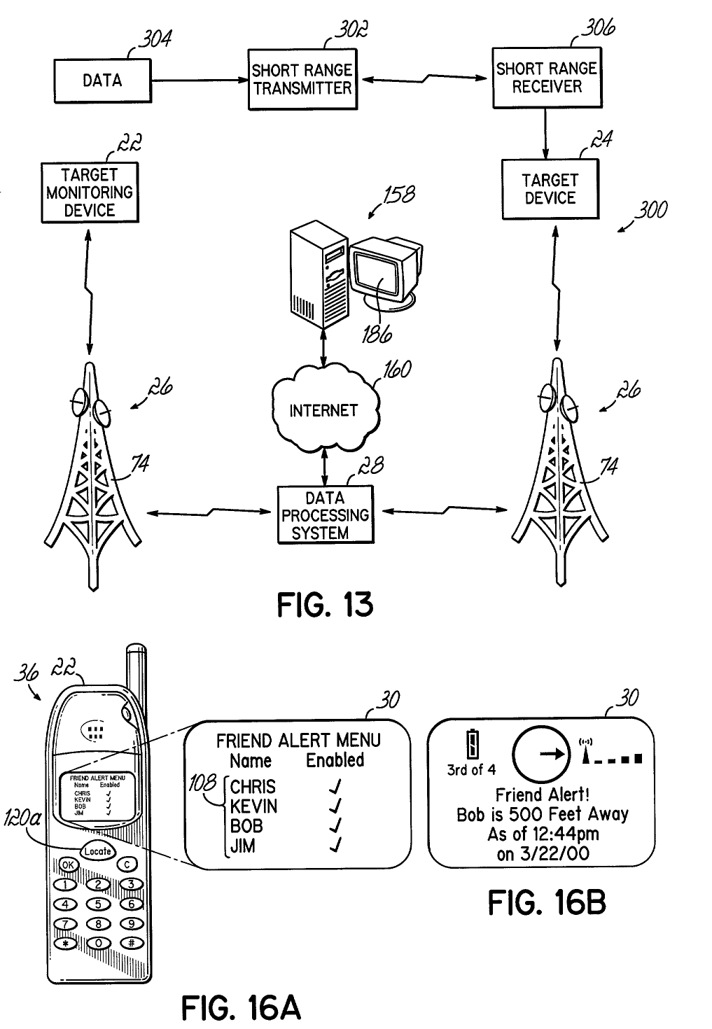

In an alternative position locating system 300 as shown in FIG. 13, where like numerals represent like parts to the position locating system 20 of FIG. 1A, the serial communication between a sensor (not shown) and the target device 24 is substituted with a short range transmitter 302 operatively coupled to a source of data 304, such as a sensor, and a short range receiver 306 operatively coupled to the target device 24. In this alternative embodiment, the short range transmitter 302 may have a relatively low power rating, i.e., two (2) Watts, and a relatively low transmitting range of less than fifty (50) feet. Data from the data source 304 is transmitted in a wireless medium to the target device 24, and the target device 24 is configured to transmit that data, as well as position data of the target device 24, to the data processing system 28 as described in detail above.

In operation of the position locating system 20 of FIG. 1A, the user of the target monitoring device 22 uses the “LOCATE” button 120a (FIGS. 3 and 6) to select one of the target devices 24 that is listed on the pre-programmed menu (not shown) displayed on the target monitoring device 22. For example, as shown in FIG. 2, “Mom” has requested the location of “Mary”. In accordance with one embodiment of the present invention, upon activating the “LOCATE” button 120a, the position data 72 (FIG. 1C) representative of the geographic position of “Mom's” target monitoring device 22, the compass heading data 126 (FIG. 1C) representative of the compass heading of “Mom's” target monitoring device 22 in degrees from magnetic North, the ID data 92 (FIG. 1C) representative of the unique device identifier of “Mom's” target monitoring device 22, and the target device ID data 104 (FIG. 1C) representative of the unique device identifier of “Mary's” target monitoring device 22 are transmitted to the data processing system 28 through the wireless communication network 26.

Block 162 in FIG. 2 represents the stored last known locations at the data processing system 28 of members of the “account” at the time of “Mom's” request for the location of “Mary's” target device 24 is processed. At block 164 in FIG. 2, the data processing system 28 evaluates the last known locations of “Mom” and “Mary” to establish data 166 that represents the distance between “Mom” and “Mary”, i.e, 1.54 miles, and data 168 that represents the compass direction from “Mom's” target monitoring device 24 to “Mary's” target device 24, i.e., 36° NNE. At block 170, the data processing system 28 also preferably includes a GEO-Coded Address (GCA) database that establishes data 172 representing the nearest geographic address of each member in the “account”, i.e., 1241 Central St, Cincinnati, Ohio 45248 for “Mary's” target device 24.

In block 174 of FIG. 2, the data processing system 28 is operable to transmit at least one, and preferably all of the distance, compass direction, and nearest geographic address data 166, 168 and 172 (FIG. 1C), respectively, to “Mom's” target monitoring device 22 through the wireless communication network 26. The distance data 166, the compass direction data 168, and time and date stamp data 88 are preferably displayed on the display 30 of “Mom's” target monitoring device 22, as shown in the exemplary embodiment of FIG. 3. Preferably, the compass direction data 168 representing the compass direction from “Mom's” target monitoring device 22 to “Mary's” target device 24 in degrees from magnetic North is displayed graphically as a graphical vector 176 (FIG. 3) on the display 30. In this way, if “Mom's” target monitoring device 22 is aligned with magnetic North, the graphical vector 176 will point or indicate the direction to “Mary's” target device 24. Of course, those of ordinary skill in the art will appreciate the many graphical representations of the compass direction data 168 that are possible without departing from the spirit and scope of the present invention. For example, the compass direction data 168 may be graphically represented by a hand (not shown) having a finger pointing to the proper compass direction, a dot (not shown) positioned at the proper compass direction or any other graphical representation that displays the proper compass direction.

In the event “Mom's” target monitoring device 22 includes a compass circuit 124 for transmitting compass heading data 126 (FIG. 1C) of “Mom's” target monitoring device 22 in degrees from magnetic North, the data processing system 28 uses the compass heading data 126 and the derived compass direction data 168 to establish data 178 (FIG. 1C) representing a relative compass heading from “Mom's” target monitoring device 22 to “Mary's” target device 24. Preferably, the data processing system 28 uses the following logic for establishing the relative compass heading data 178 from a target monitoring device 22 to a target device 24, where:

“TMD-CH”=Compass heading of the target monitoring device 22 in degrees from magnetic North;

“TMD-CD”=Compass direction from the target monitoring device 22 to the target device 24 in degrees from magnetic North; and

“RCH”=Relative compass heading from the target monitoring device 22 to the target device 24.

If “TMD-CH” is less than or equal to “TMD-CD”, then:

“RCH”=“TMD-CD”−“TMD-CH”.

If “TMD-CH” is greater than “TMD-CD”, then:

“RCH”=“360°−(“TMD-CH”−“TMD-CD”).

For example, as shown in FIGS. 14A and 14B, if the compass heading data 126 of the target monitoring device 22 in degrees from magnetic North is 15°, and the derived compass direction data 168 from the target monitoring device 22 to the target device 24 in degrees from magnetic North is 60°, then the relative compass heading from the target monitoring device 22 to target device 24 is 450, as represented by graphical vector 180 in FIG. 14B. In this way, the graphical vector 180 will always point or indicate the direction to the target device 24, regardless of the orientation of the target monitoring device 22 relative to magnetic North. By way of further example, as shown in FIGS. 15A and 15B, if the compass heading data 126 of the target monitoring device 22 in degrees from magnetic North is 315°, and the derived compass direction data 168 from the target monitoring device 22 to the target device 24 in degrees from magnetic North is 45°, then the relative compass heading from the target monitoring device 22 to the target device 24 is 90°, as represented by the graphical vector 180 in FIG. 15B.

Alternatively, the relative compass heading of the target monitoring device 22 to the target device 24 can be determined even when the target monitoring device 22 does not include a compass circuit 124 to establish the compass heading of the target monitoring device 22 in degrees from magnetic North. In this embodiment, the data processing system 28 is operable to derive the compass heading of the target monitoring device 22 from two last known locations of the target monitoring device 22, and use that derived compass heading data, in combination with the derived compass direction data 168 from the target monitoring device 22 to the target device 24 in degrees from magnetic North, to establish the relative compass heading data 178 of the target monitoring device 22 to the target device 24.

In accordance with another embodiment of the present invention, it is contemplated that the target monitoring device 22 may have the capability to compute the relative compass heading data 178 of the target monitoring device 22 to the target device 24 at the target monitoring device 22 itself. In this embodiment, the target monitoring device 22 uses the compass direction data 168 from the target monitoring device 22 to the target device 24 in degrees from magnetic North as transmitted by the data processing system 28, and the compass heading data 126 of the target monitoring device 22 in degrees from magnetic North as derived from the compass circuit 124, to establish the relative compass heading of the target monitoring device 22 to the target device 24.

In accordance with one aspect of the present invention, the target device 24 may not transmit geographic position data 84 to the data processing system 28 on a periodic basis. Rather, the target device 24 may transmit a single geographic position, or a block of several geographic positions stored in memory 96, only upon receipt of the polling signal 102 (FIG. 1C) transmitted by the data processing system 28. The polling signal 102 may be initiated and applied to the target device 24 upon activation of the “LOCATE” button 120a on the target monitoring device 22. Alternatively, the polling signal 102 may be initiated solely by the data processing system 28 upon a predetermined event or condition. As shown in FIG. 7, the target device 24 includes a DSP receiver 182 coupled to the CPU 80 that is operable to receive the polling signal 102 transmitted by the data processing system 28.

Various exemplary displays on the target monitoring device 22 are illustrated in FIGS. 3A-3F. FIG. 3A illustrates a graphical vector 184 displayed on a target monitoring device 22 that may represent a compass direction from the target monitoring device 22 to the target device 24 in degrees from magnetic North or, alternatively, a relative compass heading from the target monitoring device 22 to the target device. The nearest known geographical address of “Mary's” target device 24 is also illustrated as text data displayed on the display 30 of the target monitoring device 22 as derived from the GEO-Coded Address (GCA) database preferably maintained at the data processing systems 28. FIG. 3B illustrates a drowning alert text message displayed on a target monitoring device 22 in response to an “alarm/panic” signal initiated by a water sensor (not shown) coupled to the serial port 154 of the target device 24 as described in detail above.

FIG. 3C illustrates a kidnaping text message displayed on a target monitoring device 22 that is initiated by the data processing system 28. In accordance with this aspect of the present invention, the parents in an “account” are able to set a speed limit for one or more of their children in the “account”, for example. The data processing system 28 is able to compute the distance traveled by the child's target device 24 between two last known locations, and is also able to compute the elapsed time between the two last known locations. From this combined data, the data processing system 28 is able to compute the traveling speed of the child's target device 24. If the computed speed of the child's target device 24 exceeds a predetermined limit, the text message illustrated in FIG. 3C can be sent to the target monitoring devices 22 of the “account” to alert the parent's that their child is in an unauthorized car.

FIG. 3D illustrates a text message displayed on a target monitoring device 24 when the data processing system 28 loses communication with a target device 24. FIG. 3E illustrates a text message displayed on a target monitoring device 22 when a “low battery voltage” signal is initiated by a target device 24 as described in detail above. Lastly, FIG. 3F illustrates an “alarm/panic” text message displayed on a target monitoring device 22 as described in detail above. It will be appreciated by those skilled in the art that the content and format of the text messages illustrated in FIGS. 3 and 3A-3F can be modified without departing from the spirit and scope of the present invention.

Referring now to FIGS. 1A and 12, a representative display 186 of the computer system 158 coupled to the data processing system 28 through the global information network 160 is shown. The computer system 158 and display 186 may be located at sites of safety personnel, such as at police and fire stations, ambulance dispatch centers or hospitals, the home of “account” parents, a local public service access point, and/or at sites of businesses, for example. The data processing system 28 is preferably configured to permit access through the global information network 160 to stored position data of a target device 24 or target monitoring device 22 when proper access to that data has been attained. In this way, the location of a target device 24 and/or a target monitoring device 22, as indicated by numeral 188 in FIG. 12, can be displayed on a map 190 of the display 186. The displayed location 188 of the target device 24 and/or target monitoring device 22 may be displayed as a single location or as multiple locations according to the stored last known locations of the devices 22, 24.

Still referring to FIGS. 1A and 12, the position locating system 20 permits a zone 192 (FIG. 12) to be defined so that the data processing system 28 provides an “alarm” signal to target monitoring devices 22 of an “account”, and possibly safety personnel as well, when a target device 24 of the “account” either enters the defined zone 192 for which access is not permitted, or leaves the defined zone 192 from which departure is not permitted. The defined zone 192 is created by displaying the map 190 on the display 186 and, using cursor controls, defining a series of coordinates that define the perimeter 194 of the zone 192. A zone 192 can be defined as an allowed area or as a disallowed/forbidden zone. The zone program is then downloaded through the global information network 160 to the data processing system 28 so that the location of one or more selected target devices 24 can be monitored. It will be appreciated that the zone can also be defined at the target monitoring device 22 through entry by keys of the device 22 of geographic coordinates or other zone data, and then downloaded through the global information network 160 to the data processing system 28.

As shown in FIGS. 8-11, it is contemplated that the target monitoring devices 22 and the target devices 24 may be implemented in a wrist-worn watch device 38a (FIG. 8), 38b (FIGS. 9 and 10), and 38c (FIG. 11), where like numerals represent like parts. For example, the watch devices 38a-38c include an internal battery 196, display 30 and buttons 200. In the watch device 38b of FIGS. 9 and 10, the electronic components of the target monitoring device 22 or target device 24 have been implemented on a flex circuit tape 202 that is embedded within the wrist band 204 of the watch device 38b. The flex tape circuit 202 includes a wrist strap alarm wire 206, DSP transmitter/receiver circuit 208, CPU and associated RAM/ROM 210, GPS antenna 212, electronic compass 214, DSP antenna 216 and GPS receiver/processor 218. The wrist strap alarm wire 206 cooperates with the watch clasp 218 to provide a circuit that is operable to detect when the watch device 38b has been removed from the wearer's wrist. Alternatively, in the watch device 38c of FIG. 11, the electronic components of the target monitoring device 22 or target device 24 have been implemented as a series of circuit boards 220 that are coupled to the display 30 and battery 196 through a ribbon cable 222. The ribbon cable 222 may include an alarm circuit (not shown) that cooperates with the watch strap lock 224 and is operable to detect when the watch device 38c has been removed from the wearer's wrist.

A position locating system 400 in accordance with an alternative embodiment of the present invention is shown in FIGS. 1B and 2, where like numerals represent like parts to the position locating system 20 of FIG. 1A. In this embodiment, the wireless communication network 26 includes position location circuits 402 that are operable to determine the locations of the target monitoring devices 22 and the target devices 24 from wireless signals 404 transmitted by the devices 22, 24. The position location circuits 402 may use various algorithms known to those of ordinary skill in the art, such as time difference or arrival, angle of arrival, enhanced observed time difference or multi-path finger printing, to derive the geographic locations, such as latitude and longitude, of the target monitoring devices 22 and the target devices 24 from the wireless signals 404 transmitted by the devices 22, 24. As shown in FIGS. 1B and 2, the position location circuits 404 are coupled to the data processing system 28 and apply data 406 representing the derived geographic locations of the target monitoring devices 22 and the target devices 24 to the data processing system 28. The position location circuits 402 further apply data 408 representing the unique device identifier of the devices 22, 24, and preferably date and time stamp information (not shown) to the data processing system 28 so that the data processing system 28 can store the geographic coordinate data 86 and the date and time stamp information 88 as a record associated with the unique device identifier for each target monitoring device 22 and target device 24 as described in detail above.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicants' general inventive concept.

Having described the invention, what is claimed is:

1. A position locating system adapted to communicate with a wireless communication network, comprising:
a target device including:
a position locating circuit operable to determine a geographic position of the target device; and
a wireless communication circuit operable to transmit data representative of the determined geographic position of the target device to the wireless communication network;
a data processing system adapted to be operatively coupled to the wireless communication network and operable to receive the geographic position data transmitted by the target device, process the geographic position data transmitted by the target device into data representative of a position of the target device, and transmit the position data of the target device to the wireless communication network; and
a target monitoring device including:
a wireless communication circuit operable to receive the position data of the target device transmitted by the data processing system; and
a display operable to display the position of the target device according to the position data of the target device transmitted by the data processing system.

2. The position locating system of claim 1 wherein the target monitoring device further includes:
a position locating circuit operable to determine a geographic position of the target monitoring device; and
a wireless communication circuit operable to transmit data representative of the determined geographic position of the target monitoring device to the wireless communication network.

3. The position locating system of claim 2 wherein the data processing system is further operable to receive the geographic position data transmitted by the target monitoring device, and process the geographic position data transmitted by the target monitoring device into data representative of a position of the target monitoring device.

4. The position locating system of claim 3 wherein the data processing system is further operable to process the geographic position data transmitted by the target device and the geographic position data transmitted by the target monitoring device into data representative of a distance between the target device and the target monitoring device and transmit the distance data as the position data of the target device to the wireless communication network.

5. The position locating system of claim 4 wherein the target monitoring device is further operable to receive the distance data transmitted by the data processing system and display the distance data as the position of the target device on the display.

6. The position locating system of claim 3 wherein the data processing system is further operable to process the geographic position data transmitted by the target device and the geographic position data transmitted by the target monitoring device into data representative of a compass direction from the target monitoring device to the target device and transmit the compass direction data as the position data of the target device to the wireless communication network.

7. The position locating system of claim 6 wherein the target monitoring device is further operable to receive the compass direction data transmitted by the data processing system and display the compass direction data as the position of the target device on the display.

8. The position locating system of claim 7 wherein the target monitoring device is further operable to graphically display the compass direction data on the display.

9. The position locating system of claim 8 wherein the compass direction data is displayed on the display as a graphical vector.

10. The position locating system of claim 3 wherein the target monitoring device further includes a compass circuit operable to generate data representative of a compass heading of the target monitoring device and transmit the compass heading data to the wireless communication network.

11. The position locating system of claim 10 wherein the data processing system is further operable to process the geographic position data transmitted by the target device and the geographic position data and compass heading data transmitted by the target monitoring device into data representative of a relative compass heading from the target monitoring device to the target device and transmit the relative compass heading data as the position data of the target device to the wireless communication network.

12. The position locating system of claim 11 wherein the target monitoring device is further operable to receive the relative compass heading data transmitted by the data processing system and display the relative compass heading data as the position of the target device on the display.

13. The position locating system of claim 12 wherein the target monitoring device is further operable to graphically display the relative compass heading data on the display.

14. The position locating system of claim 13 wherein the relative compass heading data is displayed on the display as a graphical vector.

15. The position locating system of claim 1 wherein the position locating circuit of the target device comprises a GPS receiver and a GPS processor.

16. The position locating system of claim 2 wherein the position locating circuit of the target monitoring device comprises a GPS receiver and a GPS processor.

17. The position locating system of claim 1 wherein the wireless communication circuit of the target device comprises at least one of a transmitter circuit operable to transmit signals to the wireless communication network and a receiver circuit operable to receive signals from the wireless communication network.

18. The position locating system of claim 2 wherein the wireless communication circuit of the target monitoring device comprises a transmitter circuit operable to transmit signals to the wireless communication network and a receiver circuit operable to receive signals from the wireless communication network.

19. The position locating system of claim 1 wherein the position data of the target device transmitted by the data processing system comprises a nearest geographic address of the target device.

20. The position locating system of claim 1 wherein the data processing system includes a memory and is operable to store a plurality of the position data of the target device in the memory.

21. The position locating system of claim 3 wherein the data processing system includes a memory and is operable to store a plurality of the position data of the target monitoring device in the memory.

22. The position locating system of claim 1 wherein the data processing system is operatively coupled to a global information network.

23. The position locating system of claim 1 further comprising a display operatively coupled to the data processing system and operable to display the position of the target device.

24. The position locating system of claim 1 wherein the target device further includes a sensor coupled to the target device and operable to detect a predetermined condition.

25. The position locating system of claim 24 wherein the target device is further operable to transmit data representative of the predetermined condition detected by the sensor to the wireless communication network.

26. The position locating system of claim 25 wherein the sensor comprises a liquid sensor operable to detect contact of the target device with a liquid.

27. The position locating system of claim 25 wherein the sensor comprises a heat sensor operable to detect heat in the proximate area of the target device.

28. The position locating system of claim 1 wherein the target device comprises a wrist-worn watch device having time keeping functions.

29. The position locating system of claim 1 wherein the target monitoring device comprises a wrist-worn watch device having time keeping functions.

30. The position locating system of claim 1 wherein the data processing system includes a polling circuit operable to generate a polling signal and transmit the polling signal to the wireless communication network.

31. The position locating system of claim 30 wherein the target device is further operable to receive the polling signal transmitted by the data processing device and, in response to receipt of the polling signal, transmit data representative of the determined geographic position of the target device to the wireless communication network.

32. The position locating system of claim 1 wherein the target device is further operable to transmit, at a predetermined interval, data representative of the determined geographic position of the target device to the wireless communication network.

33. The position locating system of claim 2 wherein the target monitoring device is further operable to transmit, at a predetermined interval, data representative of the determined geographic position of the target monitoring device to the wireless communication network.

34. A position locating system adapted to communicate with a wireless communication network including a position locating circuit operatively coupled to the wireless communication network, comprising:
a target device including:
a wireless communication circuit operable to transmit signals to the wireless communication network whereby the position locating circuit is operable to determine a geographic position of the target device and generate data representative of the geographic position of the target device upon processing of the signals transmitted by the target device;
a data processing system adapted to be operatively coupled to the wireless communication network and the position locating circuit and operable to receive the geographic position data of the target device generated by the position locating circuit, process the geographic position data of the target device generated by the position locating circuit into data representative of a position of the target device, and transmit the position data of the target device to the wireless communication network; and
a target monitoring device including:
a wireless communication circuit operable to receive the position data of the target device transmitted by the data processing system; and
a display operable to display the position of the target device according to the position data of the target device transmitted by the data processing system.

35. The position locating system of claim 34 wherein the target monitoring device further includes:
a wireless communication circuit operable to transmit signals to the wireless communication network whereby the position locating circuit is operable to determine a geographic position of the target device and generate data representative of the geographic position of the target monitoring device upon processing of the signals transmitted by the target monitoring device.

36. The position locating system of claim 35 wherein the data processing system is further operable to receive the geographic position data of the target monitoring device generated by the position locating device, and process the geographic position data of the target monitoring device generated by the position locating system into data representative of a position of the target monitoring device.

37. The position locating system of claim 36 wherein the data processing system is further operable to process the geographic position data of the target device and the geographic position data of the target monitoring device into data representative of a distance between the target device and the target monitoring device and transmit the distance data as the position data of the target device to the wireless communication network.

38. The position locating system of claim 37 wherein the target monitoring device is further operable to receive the distance data transmitted by the data processing system and display the distance data as the position of the target device on the display.

39. The position locating system of claim 36 wherein the data processing system is further operable to process the geographic position data of the target device and the geographic position data of the target monitoring device into data representative of a compass direction from the target monitoring device to the target device and transmit the compass direction data as the position data of the target device to the wireless communication network.

40. The position locating system of claim 39 wherein the target monitoring device is further operable to receive the compass direction data transmitted by the data processing system and display the compass direction data as the position of the target device on the display.

41. The position locating system of claim 40 wherein the target monitoring device is further operable to graphically display the compass direction data on the display.

42. The position locating system of claim 41 wherein the compass direction data is displayed on the display as a graphical vector.

43. The position locating system of claim 36 wherein the target monitoring device further includes a compass circuit operable to generate data representative of a compass heading of the target monitoring device and transmit the compass heading data to the wireless communication network.

44. The position locating system of claim 43 wherein the data processing system is further operable to process the geographic position data of the target device and the geographic position data and compass heading data of the target monitoring device into data representative of a relative compass heading from the target monitoring device to the target device and transmit the relative compass heading data as the position data of the target device to the wireless communication network.

45. The position locating system of claim 44 wherein the target monitoring device is further operable to receive the relative compass heading data transmitted by the data processing system and display the relative compass heading data as the position of the target device on the display.

46. The position locating system of claim 45 wherein the target monitoring device is further operable to graphically display the relative compass heading data on the display.

47. The position locating system of claim 46 wherein the relative compass heading data is displayed on the display as a graphical vector.

48. The position locating system of claim 34 wherein the wireless communication circuit of the target device comprises at least one of a transmitter circuit operable to transmit signals to the wireless communication network and a receiver circuit operable to receive signals from the wireless communication network.

49. The position locating system of claim 35 wherein the wireless communication circuit of the target monitoring device comprises a transmitter circuit operable to transmit signals to the wireless communication network and a receiver circuit operable to receive signals from the wireless communication network.

50. The position locating system of claim 34 wherein the position data of the target device transmitted by the data processing system comprises a nearest geographic address of the target device.

51. The position locating system of claim 34 wherein the data processing system includes a memory and is operable to store a plurality of the position data of the target device in the memory.

52. The position locating system of claim 36 wherein the data processing system includes a memory and is operable to store a plurality of the position data of the target monitoring device in the memory.

53. The position locating system of claim 34 wherein the data processing system is operatively coupled to a global information network.

54. The position locating system of claim 34 further comprising a display operatively coupled to the data processing system and operable to display the position of the target device.

55. The position locating system of claim 34 wherein the target device further includes a sensor coupled to the target device and operable to detect a predetermined condition.

56. The position locating system of claim 55 wherein the target device is further operable to transmit data representative of the predetermined condition detected by the sensor to the wireless communication network.

57. The position locating system of claim 56 wherein the sensor comprises a liquid sensor operable to detect contact of the target device with a liquid.

58. The position locating system of claim 56 wherein the sensor comprises a heat sensor operable to detect heat in the proximate area of the target device.

59. The position locating system of claim 34 wherein the target device comprises a wrist-worn watch device having time keeping functions.

60. The position locating system of claim 34 wherein the target monitoring device comprises a wrist-worn watch device having time keeping functions.

61. A target monitoring device configured to monitor and display a position of a target device by communicating with a data processing system through a wireless communication network, comprising:
a wireless communication circuit operable to receive position data of the target device transmitted by the data processing system; and
a display operable to display the position of the target device according to the position data of the target device transmitted by the data processing system.

62. The target monitoring device of claim 61 wherein the position data of the target device transmitted by the data processing system comprises the nearest geographic address of the target device.

63. The target monitoring device of claim 61 wherein the position data of the target device transmitted by the data processing system comprises a distance between the target device and the target monitoring device.

64. The target monitoring device of claim 61 wherein the position data of the target device transmitted by the data processing system comprises a compass direction from the target monitoring device to the target device.

65. The target monitoring device of claim 61 wherein the position data of the target device transmitted by the data processing system comprises a relative compass heading from the target monitoring device to the target device.

66. The target monitoring device of claim 61 wherein the wireless communication circuit of the target monitoring device comprises a transmitter circuit operable to transmit signals to the wireless communication network and a receiver circuit operable to receive signals from the wireless communication network.

67. The target monitoring device of claim 61 wherein the target monitoring device comprises a wrist-worn watch device having time keeping functions.

68. A method of monitoring and displaying a position of a target device at a target monitoring device by communicating with a data processing system through a wireless communication network, comprising:
communicating from the target device to the data processing system data that is representative of the geographic position of the target device;
receiving at the data processing system the geographic position data communicated from the target device;
processing at the data processing system the geographic position data communicated from the target device into data representative of a position of the target device;
communicating from the data processing system to the target monitoring device the position data of the target device; and
displaying at the target monitoring device the position of the target device according to the position data of the target device communicated from the data processing system.

69. The method of claim 68 further comprising:
communicating from the target monitoring device to the data processing system data that is representative of the geographic position of the target monitoring device;
receiving at the data processing system the geographic position data communicated from the target monitoring device; and
processing at the data processing system the geographic position data communicated from the target monitoring device into data representative of a position of the target monitoring device.

70. The method of claim 69 further comprising:
processing at the data processing system the geographic position data communicated from the target device and the geographic position data communicated from the target monitoring device into data representative of a distance between the target device and the target monitoring device;
communicating from the data processing system to the target monitoring device the distance data as the position data of the target device; and
displaying at the target monitoring device the distance data as the position of the target device.

71. The method of claim 69 further comprising:
processing at the data processing system the geographic position data communicated from the target device and the geographic position data communicated from the target monitoring device into data representative of a compass direction from the target monitoring device to the target device;
communicating from the data processing system to the target monitoring device the compass direction data as the position data of the target device; and
displaying at the target monitoring device the compass direction data as the position of the target device.

72. The method of claim 69 further comprising:
communicating from the target monitoring device to the data processing system data that is representative of the compass heading of the target monitoring device;
receiving at the data processing system the compass heading data communicated from the target monitoring device;
processing at the data processing system the geographic position data communicated from the target device and the geographic position data and compass heading data communicated from the target monitoring device into data representative of a relative compass heading from the target monitoring device to the target device;
communicating from the data processing system to the target monitoring device the relative compass heading data as the position data of the target device; and
displaying at the target monitoring device the relative compass heading data as the position of the target device.

73. The method of claim 68 wherein the position data of the target device communicated from the data processing system comprises a nearest geographic address of the target device.

74. A method of monitoring and displaying a position of a target device at a target monitoring device by communicating with a data processing system through a wireless communication network, comprising:
transmitting signals from the target device to the wireless communication network;
processing the signals transmitted from the target device to determine a geographic position of the target device;
communicating to the data processing system data that is representative of the geographic position of the target device;
receiving at the data processing system the geographic position data of the target device;
processing at the data processing system the geographic position data of the target device into data representative of a position of the target device;
communicating from the data processing system to the target monitoring device the position data of the target device; and
displaying at the target monitoring device the position of the target device according to the position data of the target device communicated from the data processing system.

75. The method of claim 74 further comprising:
transmitting signals from the target monitoring device to the wireless communication network;
processing the signals transmitted from the target monitoring device to determine a geographic position of the target monitoring device;
communicating to the data processing system data that is representative of the geographic position of the target monitoring device;
receiving at the data processing system the geographic position data of the target monitoring device; and
processing at the data processing system the geographic position data of the target monitoring device into data representative of a position of the target monitoring device.

76. The method of claim 75 further comprising:
processing at the data processing system the geographic position data of the target device and the geographic position data of the target monitoring device into data representative of a distance between the target device and the target monitoring device;
communicating from the data processing system to the target monitoring device the distance data as the position data of the target device; and
displaying at the target monitoring device the distance data as the position of the target device.

77. The method of claim 75 further comprising:
processing at the data processing system the geographic position data of the target device and the geographic position data of the target monitoring device into data representative of a compass direction from the target monitoring device to the target device;
communicating from the data processing system to the target monitoring device the compass direction data as the position data of the target device; and
displaying at the target monitoring device the compass direction data as the position of the target device.

78. The method of claim 75 further comprising:
communicating from the target monitoring device to the data processing system data that is representative of the compass heading of the target monitoring device;
receiving at the data processing system the compass heading data communicated from the target monitoring device;
processing at the data processing system the geographic position data of the target device and the geographic position data and compass heading data of the target monitoring device into data representative of a relative compass heading from the target monitoring device to the target device;
communicating from the data processing system to the target monitoring device the relative compass heading data as the position data of the target device; and
displaying at the target monitoring device the relative compass heading data as the position of the target device.

79. The method of claim 74 wherein the position data of the target device communicated from the data processing system comprises a nearest geographic address of the target device.

80. A method of monitoring and displaying positions of a selected plurality of target devices at a target monitoring device by communicating with a data processing system through a wireless communication network, comprising:
creating an account at the data processing system comprising the selected plurality of target devices and the target monitoring device;
communicating from the selected plurality of target devices to the data processing system data that is representative of the geographic positions of the selected plurality of target devices;
receiving at the data processing system the geographic position data communicated from the selected plurality of target devices;
processing at the data processing system the geographic position data communicated from the selected plurality target devices into data representative of positions of the selected plurality of target devices;
communicating from the data processing system to the target monitoring device the position data of the selected plurality of target devices; and
displaying at the target monitoring device the positions of the selected plurality of target devices according to the position data of the selected plurality of target devices communicated from the data processing system.

81. A method of monitoring and displaying an alarm condition of a target device at a target monitoring device by communicating with a data processing system through a wireless communication network, comprising:
communicating from the target device to the data processing system data that is representative of an alarm condition of the target device;
receiving at the data processing system the alarm condition data communicated from the target device;
processing at the data processing system the alarm condition data communicated from the target device into data representative of an alarm condition of the target device;
communicating from the data processing system to the target monitoring device the alarm condition data of the target device; and
displaying at the target monitoring device the alarm condition of the target device according to the alarm condition data communicated from the data processing system.

82. The method of claim 81 further comprising:
communicating from the data processing system to the target device an acknowledgment signal upon receipt of the alarm condition data communicated from the target device.

83. A position locating system adapted to communicate with a wireless communication network, comprising:
a source of data;
a wireless transmitter operatively coupled to the source of data and operable to transmit data from the source of data in a wireless medium;
a target device including:
a wireless receiver operable to receive the data transmitted by the wireless transmitter;
a position locating circuit operable to determine a geographic position of the target device; and
a wireless communication circuit operable to transmit the data received from the wireless transmitter and data representative of the determined geographic position of the target device to the wireless communication network;
a data processing system adapted to be operatively coupled to the wireless communication network and operable to receive the data and geographic position data transmitted by the target device, process the geographic position data transmitted by the target device into data representative of a position of the target device, and transmit the data and position data of the target device to the wireless communication network; and
a target monitoring device including:
a wireless communication circuit operable to receive the data and position data of the target device transmitted by the data processing system; and
a display operable to display the data and the position of the target device according to the data and the position data of the target device transmitted by the data processing system.
